(19) United States
(12) Patent Application Publication
(10) Pub. No.: US 2008/0068301 A1
(43) Pub. Date: Mar. 20, 2008

(54) Plasma display device and driving method thereof

(76) Inventors: Seungmin Kim, Yongin-si (KR); Woojoon Chung, Yongin-si (KR); Seongjoon Jeong, Yongin-si (KR); Taeseong Kim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/889,642

(22) Filed: Aug. 15, 2007

(30) Foreign Application Priority Data
Sep. 15, 2006 (KR) 10-2006-0089772

(51) Int. Cl. G09G 3/28

(52) U.S. Cl. 345/60

(57) ABSTRACT

A driving method of a plasma display device driven by dividing one frame into a plurality of sub-fields may include generating sustain pulses to be applied to at least any one sub-field among the plurality of sub-fields as first and second sustain pulses, the first and second sustain pulses having a same cycle but different points of time when a high level voltage is applied, and supplying the first and second sustain pulses to first and a second electrodes performing an display operation during at least one sub-field.

### BACKGROUND OF THE INVENTION

1. Field of the Invention

Embodiments of the present invention relate to a plasma display device, a controller therefore, and a driving method thereof, and more particularly, to a plasma display device, controller therefore, and a driving method thereof that can vary luminance.

2. Description of the Related Art

Generally, a plasma display device is a display device using a plasma display panel (PDP) for displaying a text or an image using a plasma generated by gas discharge. The plasma display device may include a PDP for presenting a moving picture and a plurality of driving circuit portions for driving the PDP.

The plasma display device may be driven by dividing one frame into sub-fields that have respective weight values. A light emitting cell and a non-light emitting cell may be selected for an address period of respective sub-fields, and a sustain discharge may be performed for the light emitting cell, so as to actually display an image for a sustain period. Further, a gray level may be displayed by combination of the weight values of the sub-fields that are emitted from the light emitting cell.

Generally, sustain pulses are supplied simultaneously to a PDP during a sustain period, and the PDP may only vary luminance in accordance with the number of the sustain pulses in a respective sub-fields. However, luminance displayed by the same number of the sustain pulses may differ according to a load factor.

### SUMMARY OF THE INVENTION

Embodiments of the present invention are therefore directed to a plasma display device, controller therefore, and a driving method thereof, which substantially overcome one or more of the problems due to the limitations and disadvantages of the related art.

It is therefore a feature of an embodiment of the present invention to provide a plasma display device and a driving method thereof that may vary luminance.

At least one of the above and other features and advantages of the present invention may be realized by providing a driving method of a plasma display device driven by dividing one frame into a plurality of sub-fields, which may include generating sustain pulses to be applied to at least any one sub-field among the plurality of sub-fields as first and second sustain pulses, the first and second sustain pulses having a same cycle but different points of time when a high level voltage is applied, and supplying the first and second sustain pulses to first and a second electrodes performing an display operation during at least one sub-field.

The second sustain pulse may have an earlier time at which the high level voltage is applied than the first sustain pulse. Generating may include calculating a screen load factor from a plurality of image signals input for one frame, determining a total number of sustain pulses aligned to at least any one sub-field among the plurality of sub-fields according to the screen load factor, and setting a first number of first sustain pulses respectively applied to the plurality of sub-fields and setting a second number of second sustain pulses respectively applied to the plurality of sub-fields, wherein the second number may be a difference between the total number and the first number.

Setting the first and second numbers may include, when the screen load factor is high, increasing a ratio of the second number to the first number, and when the screen load factor is low, decreasing a ratio of the second number to the first number.

Generating may include converting the plurality of image signals into a plurality of sub-field data, respectively, calculating a display load factor of a relevant sub-field from data corresponding to a relevant sub-field among the plurality of sub-field data, determining a total number of sustain pulses aligned to at least any one sub-field among the plurality of sub-fields according to the display load factor, and setting a first number of first sustain pulses respectively applied to the plurality of sub-fields and setting a second number of second sustain pulses respectively applied to the plurality of sub-fields, wherein the second number is a difference between the total number and the first number.

Setting the first and second numbers may include, when the display load factor is high, increasing a ratio of the second number to the first number, and when display load factor is low, decreasing a ratio of the second number to the first number.

At least one of the above and other features and advantages of the present invention may be realized by providing a plasma display device, which may include a plasma display panel (PDP) including a plurality of first electrodes and a plurality of second electrodes performing a display operation together with the plurality of first electrodes, a controller adapted to divide one frame into a plurality of sub-fields, and generate sustain pulses as first and second sustain pulses, the first and second sustain pulses having a same cycle but different points of time when a high level voltage is applied, and a driver adapted to supply the first and second sustain pulses to the first and second electrodes.

The second sustain pulse may have an earlier time at which the high level voltage is applied than the first sustain pulse. The controller may be adapted to set a first number of first sustain pulses respectively applied to the plurality of sub-fields and a second number of second sustain pulses respectively applied to the plurality of sub-fields, wherein the second number may be a difference between a total number of sustain pulses and the first number.

The controller may be adapted to control a ratio of the second number to the first number according to a screen load factor for the frame. The controller may be adapted to increase a ratio of the second number to the first number when the screen load factor is high, and the controller may be adapted to decrease a ratio of the second number to the first number when the screen load factor is low.

The controller may be adapted to control a ratio of the second number to the first number according to a display load factor, wherein the display load factor may be a ratio of light emitting cells to non-light emitting cells, for at least any one sub-field among the plurality of sub-fields.

The controller may be adapted to increase a ratio of the second number to the first number when the screen load factor is high, and the controller may be adapted to decrease a ratio of the second number to the first number when the screen load factor is low.

The driver may include an energy recovery circuit including an energy recovery capacitor, first and second switches coupled to one terminal of the energy recovery capacitor, and an inductor coupled between the first and second switches, and a sustain voltage supplier including a third switch coupled to a power supply supplying a high level voltage and a fourth switch coupled to a power supply supplying a low level voltage.

A turn-on time of the first switch may be different for the first and second sustain pulses. A turn-on time of the third switch may be different for the first and second sustain pulses.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of a plasma display device according to an embodiment of the present invention;

FIG. 2 illustrates an arrangement of sub-fields according to an embodiment of the present invention;

FIG. 3 illustrates a driving waveform of a plasma display device according to an embodiment the present invention;

FIGS. 4a and 4b illustrate driving waveforms of first and second sustain pulses shown in FIG. 3;

FIG. 5 illustrates a driving circuit of a sustain pulse generator for generating the sustain pulses shown in FIGS. 4a and 4b;

FIGS. 6a and 6b illustrate a driving timing of a switch for generating the sustain pulses shown in FIGS. 4a and 4b, respectively;

FIG. 7 illustrates a block diagram of an embodiment of a controller of the plasma display device;

FIG. 8 illustrates a block diagram of an embodiment of the controller of the plasma display device; and

FIG. 9 illustrates a relationship between luminance and load factor of the plasma display device.

### DETAILED DESCRIPTION OF THE INVENTION

Korean Patent Application No. 10-2006-0089772, filed on Sep. 15, 2006 in the Korean Intellectual Property Office (KIPO), and entitled: “Plasma Display Device and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. Like reference numerals refer to like elements throughout.

As will be described in detail below, the plasma display device according to embodiments of the present invention may provide one or more of the following effects.

The plasma display device may supply first and second sustain pulses during respective sub-fields to a scan electrode and a sustain electrode. The first and second sustain pulses may have the same cycle but different points of time when the high level voltage is applied. By controlling a ratio of the first and second sustain pulses, the plasma display device, a controller therefore, and a driving method thereof may vary the luminance.

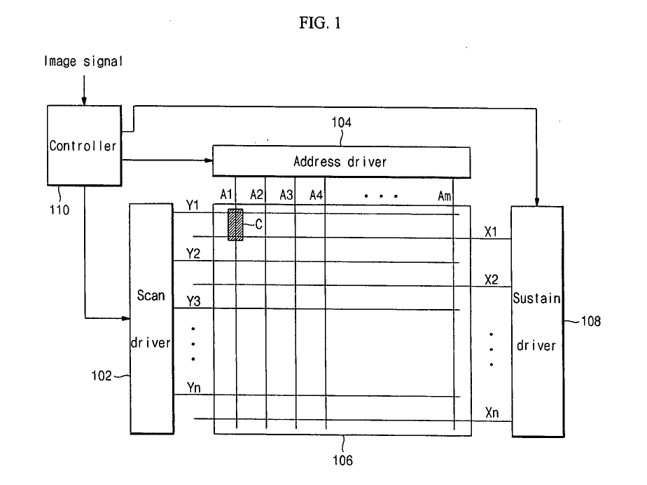

FIG. 1 illustrates a block diagram of a plasma display device according to an embodiment of the present invention.

Referring to FIG. 1, the plasma display device may include a plasma display panel (PDP) 106, an address driver 104 for supplying data to a plurality of address electrodes (A1 to Am) of the PDP 106, a scan driver 102 for driving a plurality of scan or first electrodes (Y1 to Yn), a sustain driver 108 for driving a plurality of sustain or second electrodes (X1 to Xn), and a controller 110 for controlling the drivers 102, 104 and 108, respectively.

The PDP 106 may display an image using a plurality of discharge cells (C) arranged in, e.g., a matrix. Each discharge cell (C) may be defined by a corresponding one of the plurality of address electrodes (A1 to Am) extending in a column direction, and a corresponding pair of the plurality of scan electrodes (Y1 to Yn) extending in a row direction and the plurality of sustain electrodes (X1 to Xn) extending in the row direction. The address electrodes (A1 to Am) may intersect the scan electrodes (Y1 to Yn) and the sustain electrodes (X1 to Xn).

The controller 110 may receive a vertical/horizontal synchronizing signal and may generate an address control signal, a scan control signal and a sustain control signal for respective drivers 102, 104 and 108. The generated control signal may be supplied to corresponding drivers 102, 104 and 108, so that the controller 110 may control the drivers 102, 104 and 108, respectively.

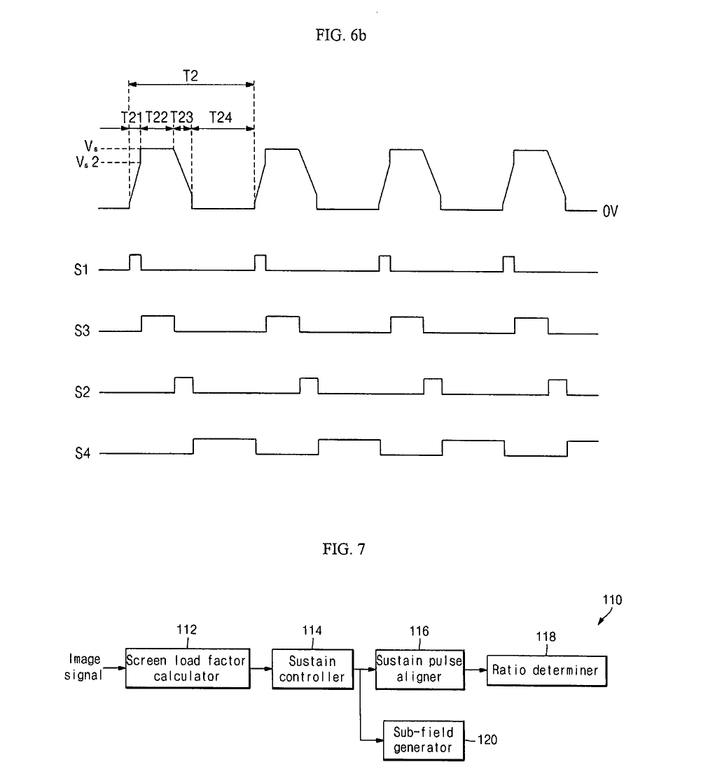

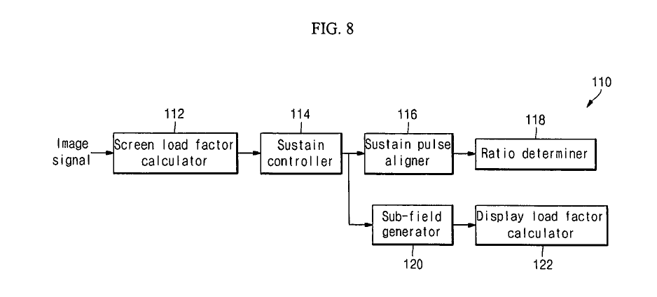

The controller 110 may be driven by dividing one frame into a plurality of sub-fields. Each sub-field may include a reset period, an address period and a sustain period. Particularly, the controller 110 may determine the total number of sustain pulses aligned to one frame by judging a load factor according to an image signal input for one frame and an auto power control (APC) level corresponding to the load factor, and may align the determined total number of sustain pulses to a plurality of sub-fields. In this case, the controller 110 may align the sustain pulses to the plurality of sub-fields so as to enable the number of sustain pulses aligned to respective sub-fields to be in proportion to a weight value of a relevant sub-field. Further, the controller 110 may classify the sustain pulses aligned to respective sub-fields into first and second sustain pulses that have the same cycle but different points of time when a high level voltage is applied. A ratio of the first and second sustain pulses that are aligned to respective sub-fields may be determined by the controller 110. The controller 110 will be explained in detail below, with reference to FIGS. 7 and 8.

The address driver 104 may supply a data signal, for selecting a light emitting cell to be displayed, to respective address electrodes (A1 to Am) in response to an address control signal output from the controller 110.

The scan driver 102 may apply a driving voltage to the scan electrodes (Y1 to Yn) in response to a scan control signal output from the controller 110. Particularly, the scan driver 102 may supply a sustain pulse having alternating high and low level voltages to the scan electrodes (Y1 to Yn) during a sustain period.

The sustain driver 108 may apply the driving voltage to the sustain electrodes (X1 to Xn) in response to a sustain control signal output from the controller 110. Particularly, the sustain driver 108 may supply a sustain pulse, having a same cycle, but is out of phase with, the sustain pulse supplied to the scan electrodes (Y1 to Yn), to the sustain electrodes (X1 to Xn) during the sustain period.

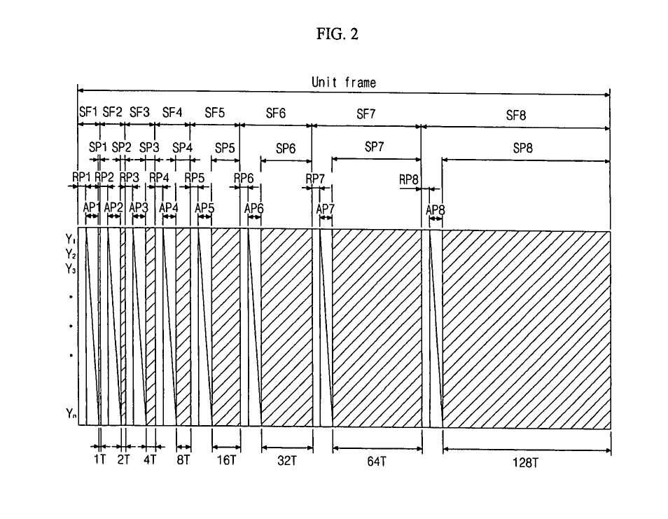

FIG. 2 illustrates an arrangement of sub-fields according to an embodiment of the present invention.

Referring to FIG. 2, the unit frame displaying the image may be divided into eight sub-fields (SF1 to SF8) so as to display a time-division gray level. The sub-fields may be divided into reset periods (RP1˜RP8), address periods (AP1˜AP8) and sustain periods (SP1˜SP8), respectively.

The luminance of the PDP may be proportional to a length of the sustain periods (SP1˜SP8) in the unit frame. The length of the sustain periods (SP1˜SP8) in the unit frame may be 255T, where T is a unit time. For the sustain period (SPn) of the nth sub-field (SFn), a time corresponding to 2ⁿ may be set, respectively. Accordingly, when sub-fields from among the eight sub-fields are appropriately selected, up to 256 gray levels, including a zero gray level, i.e., black, may be realized.

In FIG. 2, the unit frame may be divided into eight sub-fields (SF1˜SF8), a 2ⁿ weight value of a gray level of the sub-fields may be respectively aligned from the first sub field (SF1) to the eighth sub-field (SF8), e.g., 1T, 2T, . . . , and 128T. However, embodiments are not limited thereto. In other words, the number of sub-fields of the unit frame may be more than or less than eight, and the alignment of the weight value of the gray level according to respective sub-fields may be changed according to design specifications.

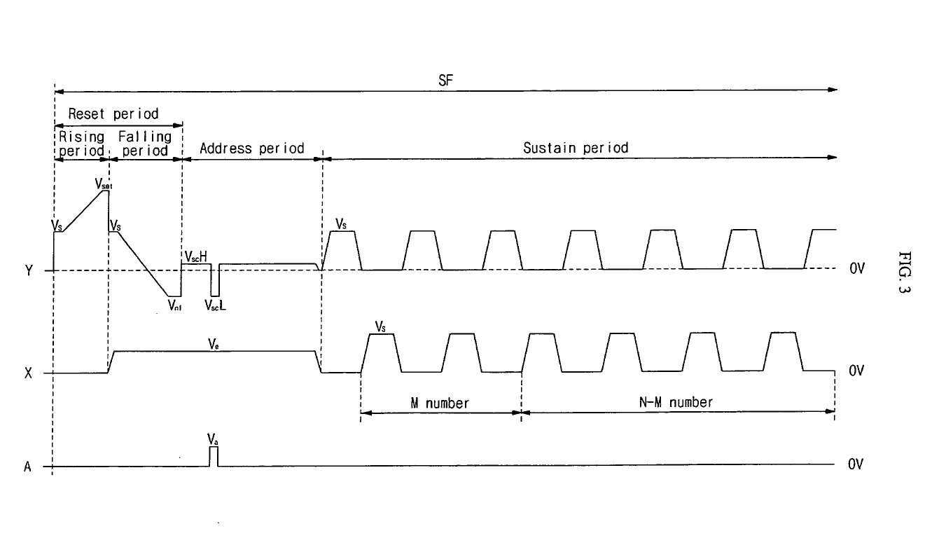

FIG. 3 illustrates a driving waveform of a plasma display device according to an embodiment the present invention.

Referring to FIG. 3, during a rising period of the reset period of respective sub-fields, a sustain electrode (X) may be maintained at a reference voltage (0V in FIG. 3), while a rising ramp pulse that gradually increases from a voltage Vs to a voltage Vset may be supplied to a scan electrode (Y). During the rising period, a weak discharge may occur between the scan electrode (Y) and the sustain electrode (X), and the scan electrode (Y) and an address electrode (A).

During a falling period of the reset period, the sustain electrode (X) may be set to a voltage Ve, while the voltage of the scan electrode (Y) may gradually decrease from the voltage Vs to a voltage Vnf. During the falling period, a weak discharge may occur between the scan electrode (Y) and the sustain electrode (X), and the scan electrode (Y) and the address electrode (A), so that a discharge cell is initialized.

During the address period, a scan pulse having a voltage VscL may be sequentially applied to the scan electrode (Y) so as to select a light emitting cell to be displayed. When the voltage VscL is not applied to the scan electrode (Y), the scan electrode (Y) may be biased at a voltage VscH. Further, an address pulse having a voltage Va may be applied to the address electrode (A) corresponding to a discharge cell to be selected. When unselected, the address electrode (A) may be biased at a reference voltage, e.g., 0V. Thus, an address discharge may be performed for the discharge cell formed by the address electrode (A) to which the voltage Va is applied and the scan electrode (Y) to which the voltage VscL is applied.

During the sustain period, a sustain pulse having a high level voltage (a voltage Vs in FIG. 3) and a low level voltage (0V in FIG. 3) may be alternately applied to the scan electrode (Y) and the sustain electrode (X). In other words, during the sustain period, the sustain pulse alternately having the high level voltage (Vs) and the low level voltage (0V) may be supplied to the scan electrode (Y), and a sustain pulse having a phase opposite to the sustain pulse supplied to the scan electrode (Y) may be supplied to the sustain electrode (X). Accordingly, a sustain discharge may occur between the scan electrode (Y) and the sustain electrode (X) of the discharge cell to be displayed.

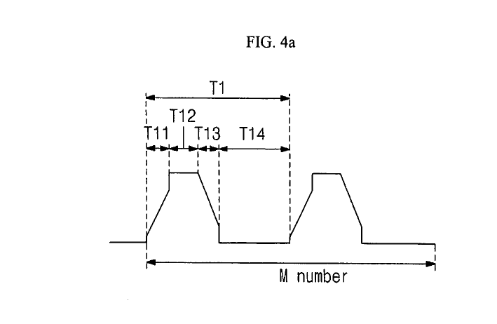

Among a plurality of sub-fields, to at least any one sub-field, M (wherein, M is a natural number) is a number of first sustain pulses as shown in FIGS. 3 and 4a applied to the sustain electrode (X), and N-M (wherein, N is a natural number and is defined as total number of sustain pulses aligned to one sub-field) is a number of second sustain pulses as shown in FIGS. 3 and 4b applied to the sustain electrode (X). As illustrated in FIGS. 3, 4a and 4b, one cycle of the first and second sustain pulses may respectively include first intervals (T11 and T21) during which the voltage rises from the low level voltage (0V) to the high level voltage (Vs), second intervals (T12 and T22) during which the high level voltage (Vs) is maintained, third intervals (T13 and T23) during which the voltage falls from the high level voltage (Vs) to the low level voltage (0V), and fourth intervals (T14 and T24) during which the low level voltage (0V) is maintained. The first sustain pulse may be repeated over a first cycle (T1) and the second sustain pulse may be repeated over a second cycle (T2), which may equal the first cycle (T1). The first interval (T21) of the second sustain pulse, during which the voltage rises from the low level voltage (0V) to the high level voltage (Vs), may be shorter than the first interval (T11) of the first sustain pulse. Thus, the first interval (T11) of the first sustain pulse may be relatively longer, so that a point in time when the high level voltage (Vs) is applied may be relatively later in the first sustain pulse. In this case, a current for sustain discharge may be supplied by a resonance current instead of a power supply supplying the high level voltage (Vs), so that the relatively weak sustain discharge is performed.

The first interval (T21) of the second sustain pulse may be relatively shorter, so that a point in time when the high level voltage is applied is relatively sooner in the second sustain pulse. Accordingly, a sustain discharge may be performed for the second interval (T22) during which the high level voltage (Vs) is applied, so that the relatively strong sustain discharge may be performed.

The plasma display device may have the same number of the sustain pulses applied to at least any one sub-field among the plurality of sub-fields as in a conventional driving scheme, however, the luminance may differ in accordance with a ratio of the first and second sustain pulses that have different points of time when the high level voltage is applied.

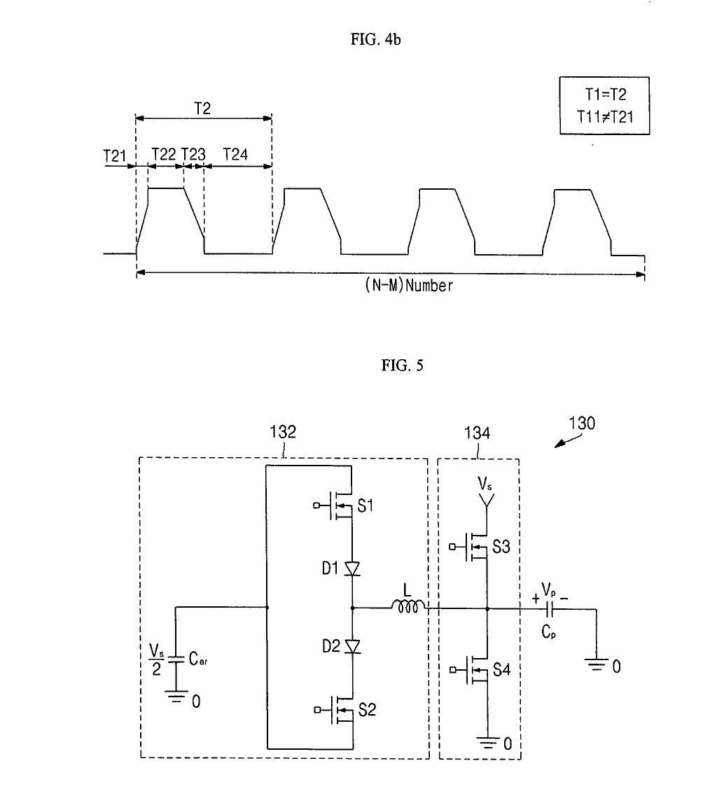

A device for generating the first and second sustain pulses that have different points of time when the high level voltage is applied as shown in FIGS. 4a and 4b will be explained in detail with reference to FIG. 5.

FIGS. 4a and 4b illustrate driving waveforms of first and second sustain pulses shown in FIG. 3, and FIG. 5 illustrates a driving circuit of a sustain pulse generator for generating the sustain pulses shown in FIGS. 4a and 4b.

As shown in FIG. 5, the sustain pulse generator 130 may include an energy recovery circuit 132 and a sustain voltage supplier 134. The sustain pulse generator 130 may be inside the scan driver 102 and the sustain driver 108.

The energy recovery circuit 132 may include first and second switches (S1 and S2), an inductor (L), first and second diodes (D1 and D2), and an energy recovery capacitor (Cer). The energy recovery capacitor (Cer) may be electrically coupled with a contact of a drain of the first switch (S1) and a source of the second switch (S2), and the first and second diodes (D1 and D2) may be respectively coupled in series with the first and second switches (S1 and S2), respectively. Further, one terminal of the inductor (L) may be electrically coupled with a contact between the first and second diodes (D1 and D2), and another terminal of the inductor (L) may be coupled with a contact between the third and fourth switches (S3 and S4) of the sustain voltage supplier 134 and may be electrically coupled in series with a scan electrode and a sustain electrode of a panel capacitor (Cp), where the panel capacitor (Cp) is an equivalent circuit capacitance of capacitance of the panel electrodes to which the sustain pulse generator 130 is connected.

The first diode (D1) may set a rising path increasing a voltage of the panel capacitor (Cp) if the first switch (S1) includes a body diode. The second diode (D2) may set a falling path decreasing a voltage of the panel capacitor (Cp) if the second switch (S2) includes a body diode. If the first and second switches (S1 and S2) do not include body diodes, the first and second diodes (D1 and D2) may be removed. The energy recovery circuit 132 may serve to charge a voltage of the scan electrode (Y) and the sustain electrode (X) at a voltage Vs or discharging the voltage into a ground voltage.

In the energy recovery circuit 132, a coupling arrangement of the inductor (L), the first diode (D1) and the first switch (S1) may be changed. Likewise, a coupling arrangement of the inductor (L), the second diode (D2) and the second switch (S2) may be changed.

The sustain voltage supplier 134 coupled between the energy recovery circuit 132 and the panel capacitor (Cp) may include third and fourth switches (S3 and S4). The third switch (S3) may be coupled between a power supply supplying a sustain voltage (Vs) and the panel capacitor (Cp), and the fourth switch (S4) may be coupled between a power supply supplying a ground voltage (0V) and the panel capacitor (Cp). The third and fourth switches (S3 and S4) may respectively supply the voltage Vs and the ground voltage (0V) to the scan electrode (Y) and the sustain electrode (X).

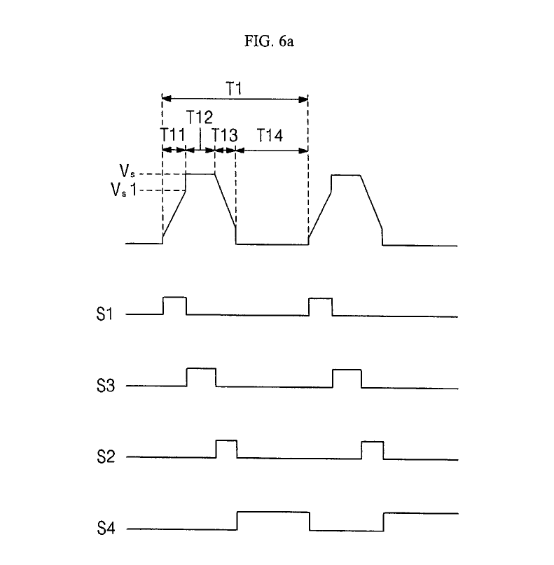

An operation of the sustain pulse generator shown in FIG. 5 will be explained in detail with reference to FIGS. 6a and 6b, which illustrate a driving timing of a switch for generating the sustain pulses shown in FIGS. 4a and 4b, respectively.

Before the intervals (T11 and T12), the fourth switch (S4) may be turned on, a voltage of both terminals of the panel capacitor (Cp) may be maintained at 0V, and a voltage (Vs/2), corresponding to ½ of the high level voltage (Vs) previously applied, may be stored in the energy recovery capacitor (Cer).

Referring to FIGS. 6a and 6b, during the first intervals (T11 and T21), the first switch (S1) may be turned on and the other switches, i.e., the second to the fourth switches (S2, S3 and S4) may be turned off. Accordingly, a current path may be formed from the first switch (S1), via the first diode (D1) and the inductor (L), to the panel capacitor (Cp). A LC resonance circuit may be formed due to the path, so that an output voltage of the PDP may be gradually increased up to the high level voltage (Vs). In order to vary the luminance, if the first sustain pulse is supplied to the scan electrode (Y) and the sustain electrode (X), as shown in FIG. 6a, a voltage of the scan electrode (Y) and the sustain electrode (X) may be increased up to a voltage Vs1 lower than the high level voltage (Vs). Further, if the second sustain pulse is supplied to the scan electrode (Y) and the sustain electrode (X), as shown in FIG. 6b, a voltage of the scan electrode (Y) and the sustain electrode (X) may be increased up to a voltage Vs2, lower than the high level voltage (Vs) and different than the voltage Vs2, i.e., may be more than or less than the voltage Vs1.

During the second intervals (T12 and T22), the third switch (S3) may be turned on and the other switches, i.e., the first, the second and fourth switches (S1, S2 and S4) may be turned off. Accordingly, a current path from the Vs power supply, via the third switch (S3), to the panel capacitor (Cp) may be formed. The scan electrode (Y) of the panel capacitor (Cp) and the sustain electrode (X) may maintain the high level voltage (Vs) by the current path.

During the third intervals (T13 and T23), the second switch (S2) may be turned on and the other switches, i.e., the first, the third and the fourth switches (S1, S3 and S4) may be turned off. Accordingly, a current path from the panel capacitor (Cp), via the inductor (L), the second diode (D2) and the second switch (S2), to the energy recovery capacitor (Cer) may be formed. A LC resonance circuit may be formed by the current path, so that the high level voltage (Vs) charged in the panel capacitor (Cp) may be discharged and reduced.

During the fourth intervals (T14 and T24), the fourth switch (S4) may be turned on, and the other switches, i.e., the first to the third switches (S1, S2 and S3) may be turned off. Accordingly, a current path from the panel capacitor (Cp), via the fourth switch (S4), to a ground terminal may be formed. The scan electrode (Y) and the sustain electrode (X) of the panel capacitor (Cp) may be maintained at the low level voltage (0V) by the current path.

It is possible to control a ratio of the first and second sustain pulses applied to respective sub-fields according to a screen load factor. When the number of light emitting cells is increased, the screen load factor may be increased and a current required for sustain discharge may be increased. Accordingly, the voltage of the scan electrode (Y) and the sustain electrode (X) may decrease, a scale of the sustain discharge may decrease, and luminance may be lowered. Accordingly, when the screen load factor is high, i.e., the luminance is low, a number of the second sustain pulse wherein the first interval (T21) is short may be increased. Further, when the screen load factor is low, i.e., the luminance is high, a number of the first sustain pulse, wherein the first cycle (T11) is long, may be increased. This will be explained in detail with reference to FIG. 7.

FIG. 7 illustrates a block diagram of an embodiment of a controller 110 of the plasma display device.

Referring to FIG. 7, the controller 110 may include a screen load factor calculator 112, a sustain controller 114, a sustain pulse aligner 116, a sub-field generator 120 and a ratio determiner 118.

The screen load factor calculator 112 may calculate a screen load factor from a plurality of image signals input for one frame. For example, the screen load factor may be calculated from an average signal level of an image signal for one frame. The plurality of image signals may respectively correspond to the plurality of discharge cells (C in FIG. 1).

The sustain controller 114 may determine the total number of sustain pulses applied to one frame according to the screen load factor. The sustain controller 114 may store the total number of the sustain pulses according to the screen load factor in a form of a lookup table, or may calculate the total number of the sustain pulses by performing a logic processing of data corresponding to the screen load factor. In other words, if the number of light emitting cells increases and the screen load factor increases, the sustain controller 114 may decrease the total number of the sustain pulses, thereby preventing power consumption from increasing.

The sustain pulse aligner 116 may align a sustain pulse aligned to one frame to a plurality of sub-fields (SF1˜SF8) so as to be in proportion to a weight value of the luminance.

The sub-field generator 120 may convert an image signal for one frame into sub-field data.

The ratio determiner 118 may determine the ratio of the first and second sustain pulses that have different ramp rates and different lengths of time during which the high level voltage is applied among sustain pulses aligned to respective sub-fields (SF1˜SF8).

Specifically, if a screen load factor output from the screen load factor calculator 112 is relatively high, the ratio determiner 118 may increase a ratio of the second sustain pulse that has a relatively early and long application of the high level voltage, rather than first sustain pulse. If a screen load factor output from the screen load factor calculator 112 is relatively low, the ratio determiner 118 may increase a ratio of the first sustain pulse that has a relatively late and short application of the high level voltage, rather than the second sustain pulse.

Accordingly, the luminance (L) displayed on a screen of the PDP may be set as a desired luminance by controlling the ratio of the first and second sustain pulses that have reach the high level voltage at different times as shown in Equation 1.

$$L = A \times \frac{M}{N} + B \times ( 1 - \frac{M}{N} ) . \qquad ( 1 )$$

Where A indicates a luminance according to the first number (M) of first sustain pulses, and B indicates a luminance according to the second number (N-M) (wherein, N is defined as total number of sustain pulses applied during one sub-field) of second sustain pulses.

In this embodiment of the present invention, a cyclic ratio of a sustain pulse may be determined by the screen load factor of one frame. However, the cyclic ratio of the sustain pulse may be determined by a display load factor of one sub-field, as will be explained with reference to FIG. 8.

FIG. 8 illustrates a block diagram of another embodiment of the controller 110 of the plasma display device according to an embodiment of the present invention.

The controller shown in FIG. 8, as compared with the controller shown in FIG. 7, may further include a display load factor calculator 122. Accordingly, detailed explanation of the same elements will be omitted.

The display load factor calculator 122 may calculate a display load factor from sub-field data corresponding to respective sub-fields (SF1˜SF8). In other words, the display load factor 122 may determine the display load factor of a relevant sub-field according to a ratio of the number of light emitting cells in respective sub-fields to the total number of discharge cells.

The ratio determiner 118 may determine a ratio of the first to the second sustain pulses according to a display load factor of a relevant sub-field in respective sub-fields. If the display load factor is high, the ratio determiner 118 may increase a ratio of second sustain pulses relative to first sustain pulses. If the display load factor is low, the ratio determiner 118 may increase a ratio of first sustain pulses relative to second sustain pulses.

Specifically, if the sustain pulse aligner 116 applies N sustain pulses to an i-th sub-field (SFi) (where i is a natural number), the ratio determiner 118 may determine the first number (M) of the first sustain pulse and the second number (N-M) of the second sustain pulse as shown in Equation 1. The ratio of the first and second sustain pulses may be determined according to the number of the light emitting cells in respective sub-fields, so that a characteristic of luminance may be uniformly maintained regardless of the number of the light emitting cells in respective sub-fields.

As described above, the plasma display device may control a ratio of the first to the second sustain pulse in which the high level voltage is applied for different time according to a screen load factor or a display load factor. However, the plasma display device may also control the ratio of the first to the second sustain pulses by other methods. Further, as described above, the plasma display device may use the first and second sustain pulses that have different durations and points of time when the high level voltage is applied. However, the plasma display device may also use three or more sustain pulses having different durations and points of time when the high level voltage is applied.

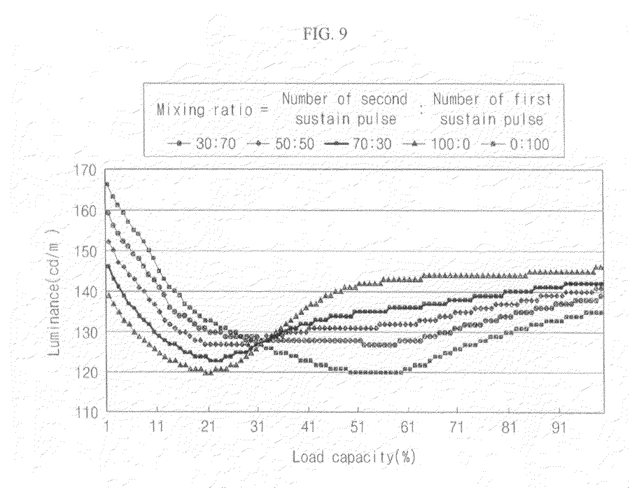

FIG. 9 illustrates a relationship between luminance and load factor of the plasma display device.

Referring FIG. 9, a ratio of the first and second sustain pulse may be controlled, so that a desired luminance may be obtained. For example, assume the number of sustain pulse applied to a sub-field is one hundred and the load capacity is 50%. When a ratio of the first and second sustain pulses is 0:100, the luminance is 140 cd/m², when the ratio of the first and second sustain pulse is 100:0, the luminance is 120 cd/m², and when the ratio of the first and second sustain pulse is 50:50, the luminance is 130 cd/m². The ratio of the first and second sustain pulse may be controlled, so that the curve of the desired luminance may be obtained. Accordingly, the luminance of the sub-field having resolution power lower than about 0.1 cd/m² may be controlled in accordance with embodiments.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A driving method of a plasma display device driven by dividing one frame into a plurality of sub-fields, comprising:
generating sustain pulses to be applied to at least any one sub-field among the plurality of sub-fields as first and second sustain pulses, the first and second sustain pulses having a same cycle but different points of time when a high level voltage is applied; and
supplying the first and second sustain pulses to first and a second electrodes performing an display operation during at least one sub-field.

2. The driving method as claimed in claim 1, wherein the second sustain pulse has an earlier time at which the high level voltage is applied than the first sustain pulse.

3. The driving method as claimed in claim 2, wherein generating includes:
calculating a screen load factor from a plurality of image signals input for one frame,
determining a total number of sustain pulses aligned to at least any one sub-field among the plurality of sub-fields according to the screen load factor, and
setting a first number of first sustain pulses respectively applied to the plurality of sub-fields and setting a second number of second sustain pulses respectively applied to the plurality of sub-fields, wherein the second number is a difference between the total number and the first number.

4. The driving method as claimed in claim 3, wherein setting the first and second numbers includes:
when the screen load factor is high, increasing a ratio of the second number to the first number, and
when the screen load factor is low, decreasing a ratio of the second number to the first number.

5. The driving method as claimed in claim 2, wherein generating includes:
converting the plurality of image signals into a plurality of sub-field data, respectively,
calculating a display load factor of a relevant sub-field from data corresponding to a relevant sub-field among the plurality of sub-field data,
determining a total number of sustain pulses aligned to at least any one sub-field among the plurality of sub-fields according to the display load factor, and
setting a first number of first sustain pulses respectively applied to the plurality of sub-fields and setting a second number of second sustain pulses respectively applied to the plurality of sub-fields, wherein the second number is a difference between the total number and the first number.

6. The driving method as claimed in claim 5, wherein setting the first and second numbers includes:
when the display load factor is high, increasing a ratio of the second number to the first number, and
when display load factor is low, decreasing a ratio of the second number to the first number.

7. A plasma display device, comprising:
a plasma display panel (PDP) including a plurality of first electrodes and a plurality of second electrodes performing a display operation together with the plurality of first electrodes;
a controller adapted to divide one frame into a plurality of sub-fields, and generate sustain pulses as first and second sustain pulses, the first and second sustain pulses having a same cycle but different points of time when a high level voltage is applied; and
a driver adapted to supply the first and second sustain pulses to the first and second electrodes.

8. The plasma display device as claimed in claim 7, wherein the second sustain pulse has an earlier time at which the high level voltage is applied than the first sustain pulse.

9. The plasma display device as claimed in claim 8, wherein the controller is adapted to set a first number of first sustain pulses respectively applied to the plurality of sub-fields and a second number of second sustain pulses respectively applied to the plurality of sub-fields, wherein the second number is a difference between a total number of sustain pulses and the first number.

10. The plasma display device as claimed in claim 9, wherein the controller is adapted to control a ratio of the second number to the first number according to a screen load factor for the frame.

11. The plasma display device as claimed in claim 10, wherein:
the controller is adapted to increase a ratio of the second number to the first number when the screen load factor is high, and
the controller is adapted to decrease a ratio of the second number to the first number when the screen load factor is low.

12. The plasma display device as claimed in claim 9, wherein the controller is adapted to control a ratio of the second number to the first number according to a display load factor, wherein the display load factor is a ratio of light emitting cells to non-light emitting cells, for at least any one sub-field among the plurality of sub-fields.

13. The plasma display device as claimed in claim 12, wherein:
the controller is adapted to increase a ratio of the second number to the first number when the screen load factor is high, and
the controller is adapted to decrease a ratio of the second number to the first number when the screen load factor is low.

14. The plasma display device as claimed in claim 7, wherein the driver comprises:
an energy recovery circuit including an energy recovery capacitor, first and second switches coupled to one terminal of the energy recovery capacitor, and an inductor coupled between the first and second switches, and
a sustain voltage supplier including a third switch coupled to a power supply supplying a high level voltage and a fourth switch coupled to a power supply supplying a low level voltage.

15. The plasma display device as claimed in claim 14, wherein a turn-on time of the first switch is different for the first and second sustain pulses.

16. The plasma display device as claimed in claim 14, wherein a turn-on time of the third switch is different for the first and second sustain pulses.

17. A plasma display device, comprising:
a PDP(Plasma Display Panel) including a plurality of first electrodes and a plurality of second electrodes performing a display operation together with the plurality of first electrodes;
a driver applying first and second sustain pulses having a low level voltage and a high level voltage higher than the low level voltage to the plurality of first and second electrodes in an opposite phase for a sustain period of at least any one sub-field among a plurality of sub-fields; and
controller setting the first and second sustain pulse so as to enable a time for changing the first into the second voltage to be different and have the same cycle.

18. The plasma display device of claim 17, wherein a point of time when a high level voltage of the first sustain pulse is applied is slower than that of the second sustain pulse.

19. The plasma display device of claim 18, wherein the controller sets the first sustain pulse as a first number from the total number of sustain pulses aligned to at least any one sub-field among the plurality of sub-fields, and the second sustain pulse as a second number, i.e., a difference of the total number and the first number.

20. The plasma display device of claim 19, wherein the controller controls a ratio of the second number to the first number according to a screen load factor for the frame or a display load factor, i.e., a ratio of a light emitting cell emitted from at least any one sub-field among the plurality of sub-fields.

21. The plasma display device of claim 20, wherein when the screen load factor or the display load factor is high, the controller increases a ratio of the second number to the first number, and when the screen load factor is low, the controller decreases a ratio of the second number to the first number.

22. The plasma display device of claim 17, wherein the driver comprises:
an energy recovery circuit; and
a sustain voltage supplier;
wherein the energy recovery circuit comprises an energy recovery capacitor, first and second switch coupled to one terminal of the energy recovery capacitor, and a resonance inductor coupled between the first and second switches, and the sustain voltage supplier comprises a third switch coupled with a power supply supplying a high level voltage, and a fourth switch coupled with a power supply supplying a low level voltage.

23. The plasma display device of claim 22, wherein an on timing of the first switch increasing the first sustain pulse from the low to the high level voltage is different from that of the first switch increasing the second sustain pulse from the low to the high level voltage.

24. The plasma display device of claim 22, wherein a turn-on point of time of the third switch determining a point of time when a high level voltage of the first sustain pulse is applied is different from that of the third switch determining a point of time when a high level voltage of the second sustain pulse is applied.
